(19) United States
(12) Patent Application Publication
(10) Pub. No.: US 2017/0052502 A1
(43) Pub. Date: Feb. 23, 2017

(54) PRINT HEAD CLEANING MECHANISM

(71) Applicant: XEROX CORPORATION, Norwalk, CT (US)

(72) Inventors: Christopher PEARCE, Hertfordshire (GB); Michael J. WILSHER, Hertfordshire (GB)

(21) Appl. No.: 14/831,867

(22) Filed: Aug. 20, 2015

(51) Int. Cl. G03G 21/00; G03G 15/16

(52) U.S. Cl. CPC G03G 21/10

(57) ABSTRACT

A print head can collect toner and contamination during use in an image forming device. A Customer Replaceable Unit (CRU) moves across the face of the print head when withdrawn. A cleaning unit, which can be a silicone blade, foam pad or other suitable material, is attached or integral to the CRU such that when the CRU is withdrawn the cleaning unit wipes the surface of the print head. Insertion of the original CRU or a new CRU would again wiped the cleaning unit over the lens surface providing the required cleaning action. Accordingly, this cleaning operation happens automatically when the CRU is replaced, and also the CRU can be pulled out and re-inserted to perform the cleaning operation if contamination is detected or at other maintenance points.

### BACKGROUND OF THE INVENTION

The disclosure relates to image forming devices. In particular, this disclosure relates to cleaning mechanisms useful for cleaning print heads in image forming devices.

Many image forming devices have replaceable sub-assemblies. These subassemblies may be arranged as units called a cartridges, and if intended for replacement may be referred to as a customer replaceable unit (CRU). Examples of a CRU may include a printer cartridge, a toner cartridge, a transfer assembly unit, a photo conductive imaging unit, a transfer roller, a toner delivery system, a fuser or drum oil unit, and the like. It may be desirable for a CRU design to vary over the course of time due to manufacturing changes or to solve post-launch problems with either the machine, the CRU, or a CRU and machine interaction. The CRU may also be provided with a monitoring device commonly referred to as a CRUM (Customer Replaceable Unit Monitor). A CRUM is typically a memory device, such as a ROM, EEPROM, SRAM, other suitable non-volatile memory device, or a combination thereof provided in or on the CRU.

An image transfer unit, such as a drum-type imaging member, a photoreceptor, or a transfer belt, may be arranged in a printing system used for offset printing adjacent to a print head. The print head may be a full width print head or array configured to deposit marking material such as ink toner or solid ink onto an outer surface of the image transfer unit. During use of the printing system, the print head can collect operational contamination e.g., toner, paper dust, debris) that inhibits the print head performance. The print head may be difficult to reach for cleaning, and it may be difficult to clean the print head on a recommended schedule, as cleaning the print head may require removal of image forming device sub-assemblies or components in order to access the print heads.

### BRIEF SUMMARY OF THE INVENTION

This summary is provided to introduce a selection of concepts in a simplified form that are further described below in the detailed description. This summary is not intended to identify essential features of the claimed subject matter, nor is it intended for use in determining the scope of the claimed subject matter.

According to aspects illustrated herein, there is provided a customer replaceable unit configured for use in an image forming device having a print head, with the customer replaceable unit including an image transfer unit configured to transfer a print image to a print media, and a cleaning unit. The cleaning unit is directly attached to the image transfer unit and is configured to automatically clean a surface of the print head by rubbing against the surface of the print head upon an insertion or withdrawal of the image transfer unit within the image forming device.

The exemplary embodiments also include a method for reconditioning a customer replaceable unit for use in an image forming device having a print head. The method includes inserting print media marking material in a cartridge of the customer replaceable unit mountable within the image forming device adjacent a print head configured for imaging onto an imaging member within the image forming device, with the imaging member configured to transfer a print image to a print media, and reconditioning a cleaning unit of the cartridge, with the cleaning unit configured to automatically clean a surface of the print head by rubbing against the surface of the print head upon an insertion or withdrawal of the cartridge within the image forming device. Such reconditioning of the cleaning unit may include cleaning or replacing the cleaning unit.

The exemplary embodiments further include a method for automatically cleaning a print head within an image forming device. The exemplary method includes disengaging a print head from a cammed position adjacent an imaging member within the image forming device, the disengagement of the print head releasing a customer replaceable unit to a slideable configuration within the image forming device adjacent the print head, the customer replaceable unit mountable within the image forming device adjacent the print head configured for imaging onto an imaging member within the image forming device, the imaging member configured to transfer a print image to a print media, and withdrawing the released customer replaceable unit out of the image forming device to automatically clean a surface of the print head by rubbing a cleaning unit integral with the customer replaceable unit against the surface of the print head upon the withdrawal of the customer replaceable unit.

The exemplary embodiments still further include a print head cleaning mechanism useful in an image forming device having a print head. The print head cleaning mechanism includes a customer replaceable unit and a cleaning unit. The customer replaceable unit is intentionally designed for use in the image forming device, with the customer replaceable unit mountable within the image forming device adjacent the print head. The cleaning unit is integral with the customer replaceable unit to contact the print head, with the cleaning unit intentionally designed to automatically clean a surface of the print head by rubbing against the surface of the print head upon an insertion or withdrawal of the customer replaceable unit within the image forming device.

Exemplary embodiments are described herein. It is envisioned, however, that any system that incorporates features of systems described herein are encompassed by the scope and spirit of the exemplary embodiments.

### BRIEF DESCRIPTION OF THE DRAWINGS

Various exemplary embodiments of the disclosed apparatuses, mechanisms and methods will be described, in detail, with reference to the following drawings, in which like referenced numerals designate similar or identical elements, and:

FIG. 1 is a perspective view of a print head cleaning mechanism in accordance with an exemplary embodiment;

FIG. 2 shows the print head cleaning mechanism of FIG. 1 partially in section with exemplary image forming components;

FIG. 3 shows the print head cleaning mechanism of FIG. 1 at a cleaning stage within an exemplary image forming device;

FIG. 4 shows the print head cleaning mechanism of FIG. 1 at another cleaning stage within an exemplary image forming device;

FIG. 5 is a diagrammatical side view of a plurality of print head cleaning mechanisms within an exemplary image forming device; and

FIG. 6 is a perspective view of a print head cleaning mechanism in accordance with another exemplary embodiment.

### DETAILED DESCRIPTION OF THE INVENTION

The present invention will be illustrated in more detail with reference to the accompanying drawings, and which preferred embodiments of the invention are shown. This invention may, however, be embodied in many different forms and should not be construed as limited to the embodiments set forth below. Rather, these exemplary embodiments are provided so that this disclosure will be thorough and complete, and will fully convey the scope of the invention to those skilled in the art. Accordingly, the exemplary embodiments are intended to cover all alternatives, modifications, and equivalents as may be included within the spirit and scope of the apparatuses, mechanisms and methods as described herein.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value.

The term “image forming device” or “printing device” as used herein refers to a digital copier or printer, scanner, image printing machine, xerographic device, digital production press, document processing system, image reproduction machine, bookmaking machine, facsimile machine, multi-function machine, or the like and can include several marking engines, feed mechanism, scanning assembly as well as other print media processing units, such as paper feeders, finishers, and the like. An image forming device can handle sheets, webs, marking materials, and the like, and can place marks on any surface. The term “print media” generally refers to a usually flexible, sometimes curled, physical sheet of paper, substrate, plastic, or other suitable physical print substrate for images, whether precut or web fed.

The term “imaging member” is a unit that holds marking material, such as toner or ink, in an imagewise or reverse-imagewise fashion for eventual transfer to print media. In a xerographic or electrophotographic context, for example, such a unit could be a photoreceptor drum or belt, or an image-transfer drum or belt that receives marking material from one or more photoreceptors, and subsequently transfers the marking material to print media. In an ink-jet context, an imaging member can be an image-transfer drum or belt that receives marking material from one or more ink-jet print heads and subsequently transfers the marking material to print media.

The term “print head,” is a structure, such as a window, adjacent to or otherwise associated with an LED array or light path for latent imaging onto an imaging member via a laser raster scanner, for xerographic printing. For ink-jet printing, a printhead may be defined as any structure from which ink is emitted in imagewise fashion toward the imaging member.

As used herein, an “image transfer unit” is any hardware useful or incidental to the imagewise transfer of marking material from the imaging member to a print sheet or other print media. For example, an image transfer unit may be a CRU, toner cartridge, print cartridge, or part thereof

Reference is made to the drawings to accommodate understanding of image forming devices for toner or ink-based digital printing, which may include direct or offset printing of ink images. In printing systems having an imaging member in accordance with an embodiment, the imaging member (e.g., photoreceptor drum, transfer belt) may be arranged in operable proximity to a print head (e.g., Light-Emitting Diode (LED), ink-jet, thermal, dot-matrix, laser, light shutter) or print head array. The print head may be configured to provide an image onto a surface of the imaging member via latent imaging formed by light emission from an LED array or light path, or by emitting marking material such as toner, solid ink, aqueous inks, UV curable inks, gel inks, or other molten and/or fluid materials in imagewise fashion onto the imaging member as the imaging member rotates, for example, about a central longitudinal axis. During operation of the image forming device, the print head can collect contamination (e.g., toner, ink, paper dust, debris) that inhibits the print head performance.

In order to clean the print heads, a CRU is provided with an integral cleaning mechanism (e.g., silicone or elastomeric blade or pad, resilient blade or pad, felt, foam or cloth pad) which when inserted or removed, rubs the cleaning mechanism across the lens surface wiping off any collected contamination. The term “silicone” is well understood in the arts and refers to polyorganosiloxanes having a backbone formed from silicon and oxygen atoms and sidechains containing carbon and hydrogen atoms. Other functional groups may be present in the silicone rubber, for example vinyl, nitrogen-containing, mercapto, hydride, and silanol groups, which are used to link siloxane chains together during crosslinking.

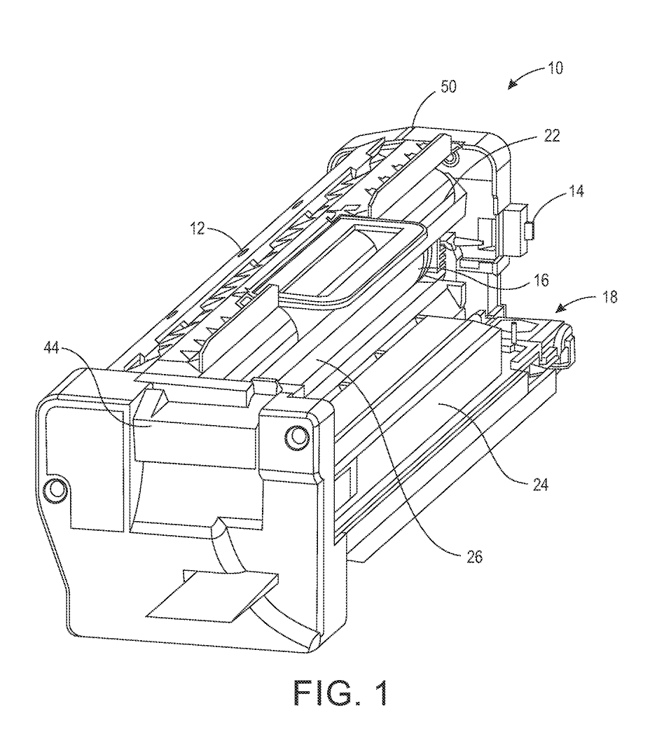

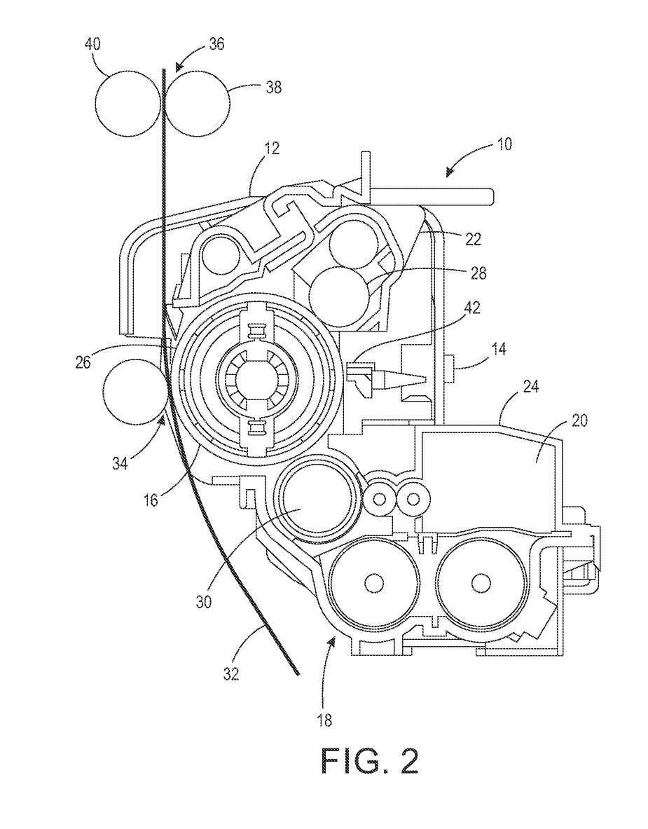

FIGS. 1 and 2 depict a print head cleaning mechanism 10 of an image forming device in accordance with an exemplary embodiment. The print head cleaning mechanism 10 includes a customer replaceable unit (CRU) 12, also referred to herein generally as a xerographic replaceable unit, an image transfer unit or a print cartridge, integrated with a cleaning unit 14. Without being limited to a particular theory, the print cartridge 12 may include a photoreceptor 16, a toner delivery system 18, toner 20 (FIG. 2), and a bias charge applicator 22 within a CRU housing 24. The print cartridge 12 may also be a toner cartridge housing the toner 20 or housing the toner and the toner delivery system 18. In other words, the print cartridge 12 is not limited to housing any particular one or more components used in an image delivery device. For example, the print cartridge may also include a CRUM memory device.

The photoreceptor 16 is a type of imaging member shown as a drum having an outer circumferential surface 26 for image transfer, and may be configured for imaging using the toner delivery system 18 that contacts the photoreceptor to provide toner onto the outer circumferential surface, and the bias charge applicator 22 that charges the photoreceptor 16 for xerographic printing. In particular, the bias charge applicator 22 may include a conductive roller 28 that selectively applies the electric charge to the photoreceptor 16 that is used to attract toner 20 for xerographic printing. The toner delivery system 18 may include a toner roller 30 that receives and applies toner 20 that may be housed in the CRU housing 24 onto the photoreceptor 16.

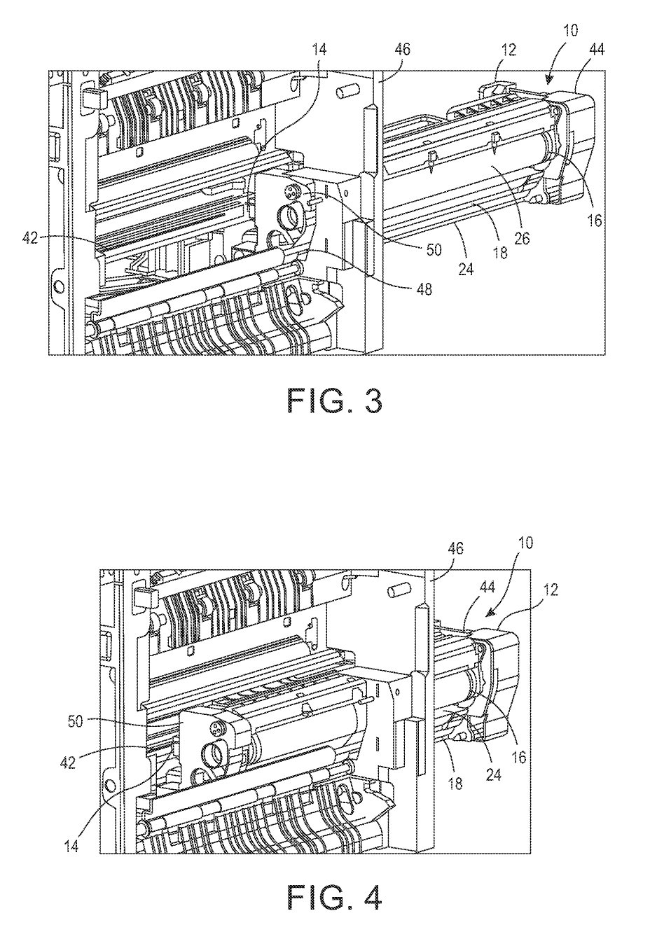

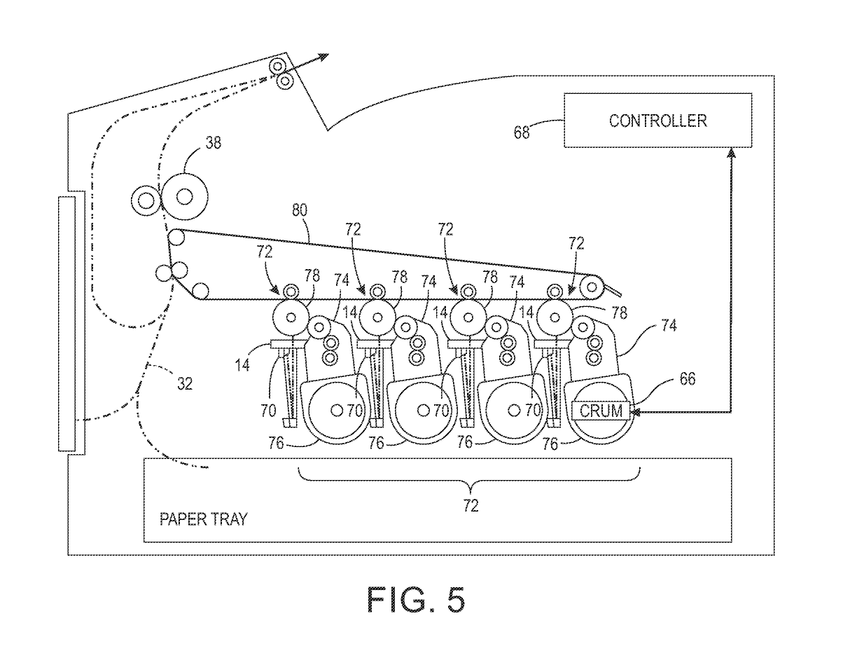

The photoreceptor 16 may be formed of aluminum or other suitable material and rotatable about a central longitudinal axis. For example, the imaging member may be rotated in the direction shown by the arrow A. The outer circumferential surface 26 may include an overcoat material suitable for printing. In other words, the surface 26 may be formed to accept an image, and carry the image for transfer to a substrate such as print media 32 or another imaging member (e.g., transfer belt 80, see FIG. 5). In particular, the outer circumferential surface 26 may be configured to receive print media marking material (e.g., toner, ink) that may be deposited in the form of an image on the outer surface. The deposited image may be carried past one or more processing stations (not shown), and may be carried to a transfer or transfix nip 34 (FIG. 3) where the image is transferred from the outer circumferential surface 26 to a substrate surface of the print media 32. The print media 32 passes through a fuser 36 that melts the toner into the print media, with the fuser including a fuser roll 38 and a pressure roll 40 that forms a nip there between through which the print media is conveyed in order to permanently fuse the image onto the print media.

Still referring to FIGS. 1 and 2, the cleaning unit 14 is shown integrated with the print cartridge 12 to contact and clean a print head 42 of the image delivery device, as described by example in greater detail below. The cleaning unit may be integral with the print cartridge 12 via direct attachment or bonding there between. The direct attachment may be a permanent bond or a renewable bond via a fastener (e.g., screw, clamp) that may be removed and replaced with a clean or new cleaning unit 14 fixedly attached to the print cartridge 12 preferably via a fastener. The fastener may directly attach the cleaning unit 14 to the cartridge 12 by connecting a housing holding the cleaning unit to the cartridge. The cleaning unit 14 may include a resilient elastomeric or silicon blade, or other cleaning member, such as an elastomeric, resilient, conformable, silicon, foam, felt or cloth pad intentionally designed to strip contamination (e.g., toner, paper dust, debris) from a print head 42 when the cleaning unit is rubbed against the print head. It is understood that the cleaning unit 14 is intentionally designed to clean a contaminated surface of the print head 42 upon rubbing or swiping the print head, and is not limited to any particular shape, material or other structure useful for that purpose.

The cleaning unit 14 is fixed to the print cartridge 16 via a bond there between. For example, the cleaning unit 14 may be bonded to the print cartridge 16 via a clamp, attached via a fastener (e.g., screw) or other mechanical bonding approach as well understood by a skilled artisan. In addition, the cleaning unit 14 may be bonded to the print cartridge 16 via an adhesive or other chemical bond as well understood by a skilled artisan. The bonding holds the cleaning unit 14 to the print cartridge 16 during repeated rubbing interaction between the cleaning unit and print head(s) 42 of a printer when one is moved against the other, for example, during insertion or withdrawal of the print cartridge in an image forming device. To aid in the insertion and withdrawal of the print cartridge 16 in the image forming device 46 , the print head cleaning mechanism 10 may also include a handle 44 attached at a proximal end of the CRU housing 24 for support while moving the print cartridge.

FIGS. 3 and 4 depict the print head cleaning mechanism 10 of FIG. 1 at cleaning stages within the image forming device 46 having the print head 42 (e.g., LED, laser, ink-jet). In this example, the print head 42 is preferably an LED print head and the image forming device is preferably a xerographic image forming device. The print head cleaning mechanism 10 includes the print cartridge 12, which is mountable within the image forming device 46 adjacent the print head. To receive the print cartridge 12, a suitable recess 48 is provided in the image forming device 46, with the print cartridge body and the recess having complementary shapes and dimensions such that on insertion of the print cartridge into the recess, the print head 42 is in a predetermined relation with the print cartridge and in particular with the cleaning unit 14 integral therewith.

Without being limited to a particular theory, the print cartridge 12 is slidably mounted along direction arrow B through the recess 48 adjacent the print head 42, yet may also be rotatably mounted or otherwise engageable into the image forming device adjacent the print head. In particular, when the print cartridge 12 is inserted through the recess 48 and into the image forming device 46, the cleaning unit 14 integral with the print cartridge rubs against the print head 42. Likewise, retrieval of the print cartridge out of the image forming device 46 via the recess 48 also causes the cleaning unit 14 to rub against the print head 42. The rubbing of the cleaning unit 14 against the print head 42 provides an automatic cleaning action of the surface of the print head in contact with the cleaning unit and removes contamination (e.g., toner, paper dust, debris, ink) from the print head. As can be seen in FIGS. 1-4, the cleaning unit 14 is fixed to the distal end 50 of the print cartridge 12 at a side of the print cartridge away from, or opposite the photoreceptor 16. This provides the benefit of a complete swipe of the print head 42 or print head array while keeping the contamination removed from the print head away from the outer circumferential surface 26 of the photoreceptor 16.

The recess 48 is an aperture intentionally designed to receive the print cartridge 12 for insertion of the print cartridge into the image forming device 46 to an engaged position for operation thereof FIG. 3 shows the print cartridge 12 at initial insertion into the recess 48, or as the print cartridge 12 is nearly removed from the image forming device 46. FIG. 4 shows the print cartridge 12 when further inserted into the recess 48 than shown in FIG. 3. At this stage, the cleaning unit 14 is abutting the print head 42 such that movement of the print cartridge 12 further into or out of the recess 48 causes the cleaning unit to swipe and automatically clean the print head surface rubbed by the movement of the print cartridge against the print head.

Insertion of the print cartridge 12 fully into the recess 48 provides a full cleaning swipe of the cleaning unit 14 across the print head, and places the print cartridge in an engaged pre-operable position within the image forming device 46. When in the engaged position, the print head 42 may be cammed on and shifted to an operable position adjacent the photoreceptor 16 for an imaging operation of the print head onto the photoreceptor. When the print head 42 is in the operable position (FIG. 2), the print cartridge 12 preferably cannot be removed as this may cause damage to the print head due at least to its shifted position towards the photoreceptor 16.

In order to withdraw the print cartridge 12 from the image forming device 46, the print head 42 may be disengaged and withdrawn from its operable (cammed on) position adjacent the photoreceptor 16 (FIG. 2) to a withdrawn (cammed off) position away from the photoreceptor where the print head is aligned adjacent the cleaning unit 14 (FIGS. 3 and 4). This withdrawal of the print head 42 releases the print cartridge 12 to a movable (e.g., slideable, rotatable) configuration within the recess 48 adjacent the print head, whereupon the print cartridge can be withdrawn from the image forming device 46, which wipes the cleaning unit 14 across the print head surface and cleans the print head.

Accordingly, the print head 42 is aligned in rubbing contact with the cleaning unit 14 during the insertion or withdrawal of the print cartridge within the recess 48, and the print head may be shifted towards the photoreceptor and out of alignment with the cleaning unit when the print cartridge is in the engaged fully inserted pre-operable position. Further, while the insertion and withdrawal of the print cartridge within the image forming device is a sliding movement in alignment with the print heads, it is understood that other configurations are within the scope of the invention, including a rotation movement of the print cartridge against the print head for the rubbing cleaning action. The automatic cleaning of the print head 42 upon insertion and retrieval of the print cartridge 12 provides the benefit of print head cleaning regularly whenever the print cartridge needs to be replaced or serviced e.g., when the toner 20 in the print cartridge is low) without the need of an independent indication to clean the print head. Also, automatic cleaning of the print head 42 upon insertion ensures a clean print head at the beginning of the print cartridge 12 use cycle. Of course, the print head 42 can be cleaned intermittently as described herein before the print cartridge use has expired.

FIG. 5 depicts a plurality of print head cleaning mechanisms 60 within an exemplary image forming device 62 with print cartridges 64 each including a Consumable Replaceable Unit Monitor (CRUM) 66 in communication with a controller 68. The image forming device 62 may be an xerographic device, such as a laser printer with a plurality of image forming stations 72, each having a laser or LED print head 70 employing a photoreceptor cartridge and a replaceable print cartridge 64, which may include a toner delivery system 74 and a toner cartridge 76 respectively, each of which is designed to provide a number of images in the form of prints or copies. The photoreceptor cartridge may include a photoreceptor 78 and a bias charge applicator 22 (not shown) for charging the outer surface of the photoreceptor in preparation for imaging. Each photoreceptor 78 is shown in communication with a respective print head 70 and print cartridge 64, and may be separable from the print cartridge 64.

Still referring to FIG. 5, the print cartridge 64 is shown integrated with a cleaning unit 14 to contact and clean a print head 70 of the image delivery device 62. Preferably the cleaning unit 14 is fixed to the distal end of the print cartridge 64 via a bond there between for a complete cleaning swipe of the print head. To receive a print cartridge 64, a suitable recess 48 is provided in the image forming device 62, with the print cartridge and the recess preferably having complementary shapes and dimensions such that on insertion of the print cartridge into the recess, or retraction of the print cartridge out of the recess, the cleaning unit 14 integral with the print cartridge rubs against the print head 70. The rubbing of the cleaning unit 14 against the print head 70 provides an automatic cleaning action of the surface of the print head in contact with the cleaning unit via rubbing action there between and removes contamination (e.g., toner, paper dust, debris) from the print head in the manner described above under reference to FIGS. 1-4. It should be noted that in this exemplary configuration, the print head 70 may not require shifting to cammed on or off positions between engagement and disengagement of the print cartridge 64.

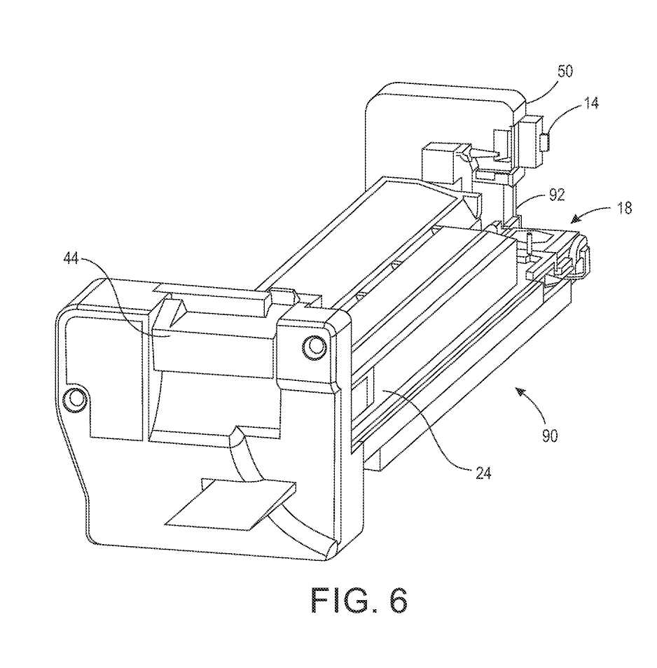

FIG. 6 depicts a print head cleaning mechanism 90 in accordance with another exemplary embodiment. In summary, the print head cleaning mechanism 90 is shown similar to the print head cleaning mechanism 10 discussed above an illustrated in FIGS. 1-4. In particular, the print head cleaning mechanism 90 includes a print cartridge 92 similar to the print cartridge 12, integral with a cleaning unit 14, and including the toner delivery system 18 and housing for the toner 20. Again, the cleaning unit 14 is fixed preferably to the distal end of the print cartridge 92 via a bond there between for a complete cleaning swipe of the print head. The print cartridge 92 does not include the photoreceptor 16 and bias charge applicator 22, which may not need replacement as often as a toner cartridge. This provides the benefit of timely replacement of the print cartridge 92 when its toner supply is low, while keeping components (e.g., photoreceptor, bias charge applicator) with a longer run time in the image forming device 46. In other words, FIG. 6 illustrates another example where the print cartridge 12 is not limited to housing any particular one or more components used in an image delivery device. It is also appreciated that the print cartridge may merely include storage for the toner 20, with the toner deliver system included in a separate housing.

As noted above, the retrieval of a used CRU/print cartridge/toner cartridge from the image forming device cleans the print head(s). The used cartridge may be refurbished or reconditioned for further use, as well understood by a skilled artisan, for example by adding toner to the cartridge. During this reconditioning, the cleaning unit may be replaced or cleaned for further use. For example, the cleaning unit may be cleaned by soaking, brushing or wiping the contaminants from the cleaning unit with a cleaning solution (e.g., alcohol, low volatile or nonvolatile organic compound solution). Of course the cleaning unit may be temporarily removed from the CRU for cleaning and reattached to the CRU after cleaning with a fastener or chemical bond. The cleaning unit may also be replaced with a clean or unused cleaning unit, for example if it becomes inefficient or difficult to sufficiently clean the cleaning unit, such as if the cleaning unit is a felt pad.

It will be appreciated that the above-disclosed and other features and functions, or alternatives thereof, may be desirably combined into many other different systems or applications. For example, while the image forming devices are exemplified in the description and drawings as a printer, other types of reproducing machines such as digital copiers, scanners, image printing machines, xerographic devices, digital production presses, document processing systems, image reproduction machines, bookmaking machines, facsimile machines, multi-function machines, or the like may be envisioned. Moreover, the customer replaceable unit and attached cleaning unit may also be rotated against the print head for the cleaning action. Further, the cleaning unit may be modified to rub against and clean other components that may suffer performance loss due to contamination accumulation in an image forming device and can be aligned with the cleaning unit at insertion into and withdrawal from the image forming device, for example, a bias charge applicator or roller. In addition, when the print heads are part of a customer replaceable unit, then the cleaning unit may be attached to the an image forming device in alignment with the print heads of the customer replaceable unit to clean the print heads upon removal out of or insertion of the customer replaceable unit into the image forming device. Also, various presently unforeseen or unanticipated alternatives, modifications, variations or improvements therein may be subsequently made by those skilled in the art.

1. A customer replaceable unit configured for use in an image forming device having a print head, comprising:
an image transfer unit configured to transfer a print image to a print media; and
a cleaning unit directly attached to the image transfer unit, the cleaning unit configured to automatically clean a surface of the print head by rubbing against the surface of the print head upon an insertion or withdrawal of the image transfer unit within the image forming device,
wherein the image transfer unit is a unitary member including both a marking material cartridge housing the print media marking material and a print cartridge housing an imaging member, the marking material cartridge and the an imaging member being coupled together independent of a spatial relationship between the image transfer unit and the image forming device, with the imaging member rotatably associated with the marking material cartridge, the imaging member and marking material cartridge being configured to maintain the coupling relationship there between during an insertion into the image forming device and during a withdrawal from the image forming device,
the image forming device having an aperture configured to receive the image transfer unit for insertion of the image transfer unit into the image forming device to an engaged position for operation thereof, the image transfer unit having a distal end and a proximal end opposite the distal end, the distal end being fully inserted through the aperture when the image transfer unit is in the engaged position within the image forming device, wherein the cleaning unit is attached to the distal end of the image transfer unit,
the print head configured for alignment in rubbing contact with the cleaning unit during the insertion or withdrawal of the image transfer unit, and the print head configured to shift towards an imaging member and out of rubbing contact alignment with the cleaning unit When the image transfer unit is in the engaged position with the print head configured to block insertion or withdrawal of the image transfer unit while in the engaged position, the relationship between the imaging member and the cleaning unit remaining constant during the insertion and withdrawal of the image transfer unit, a shifting of the print head from the engaged position releasing the image transfer unit to a slideable configuration within the aperture of the image forming device.

2. (canceled)

3. The customer replaceable unit of claim 1, wherein the cleaning unit includes a resilient blade.

4. The customer replaceable unit of claim 3, wherein the resilient blade is a silicone blade.

5. The customer replaceable unit of claim 1, wherein the cleaning unit includes a foam pad.

6. The customer replaceable unit of claim 1, wherein the cleaning unit includes a felt pad.

7. The customer replaceable unit of claim 1, the image transfer unit storing print media marking material configured for deposit onto the print media.

8. The customer replaceable unit of claim 1, the cleaning unit configured to automatically clean the surface of the print head upon both removal of the image transfer unit from the image forming device and insertion of the image transfer unit into the image forming device.

9. The customer replaceable unit of claim 1, wherein the print head is a LED print head.

10. The customer replaceable unit of claim 1, wherein the image transfer unit is mountable within the image forming device adjacent the print head configured for imaging onto an imaging member within the image forming device, and the imaging member is configured to transfer the print image to the print media at a first side of the print cartridge.

11. The customer replaceable unit of claim 10, wherein the cleaning unit is attached to a second side of the print cartridge opposite the first side.

12. (canceled)

13. (canceled)

14. The customer replaceable unit of claim 1, the proximal end including a handle for support during insertion of the image transfer unit through the aperture and into the image forming device, and during withdrawal of the image transfer unit out of the image forming device via the aperture.

15. The customer replaceable unit of claim 1, wherein the aperture accepts the insertion or withdrawal of the image transfer unit within the image forming device in a sliding movement in alignment with the print heads.

16. A method for automatically cleaning a print head within an image forming device, comprising:
disengaging a print head from a cammed position adjacent an imaging member within the image forming device, the disengagement of the print head releasing an image transfer unit to a slideable configuration within the image forming device adjacent the print head, the image transfer unit being a unitary member including both a marking material cartridge housing the print media marking material and a print cartridge housing an imaging member, the marking material cartridge and the an imaging member being coupled together independent of a spatial relationship between the image transfer unit and the image forming device, with the imaging member rotatably associated with the marking material cartridge, the imaging member and marking material cartridge being configured to maintain the coupling relationship there between during a withdrawal from the image forming device, the image transfer unit mountable within the image forming device adjacent the print head configured for imaging onto an imaging member within the image forming device, the imaging member configured to transfer a print image to a print media, the image forming device having an aperture configured to receive the image transfer unit for insertion of the image transfer unit into the image forming device to an engaged position for operation thereof, the image transfer unit having a distal end and a proximal end opposite the distal end, the distal end being fully inserted through the aperture when the image transfer unit is in the engaged position within the image forming device, wherein the cleaning unit is attached to the distal end of the image transfer unit,
the print head configured for alignment in rubbing contact with the cleaning unit during the withdrawal of the image transfer unit, and the print head configured to shift towards an imaging member and out of rubbing contact alignment with the cleaning unit when the image transfer unit is in the engaged position with the print head configured to block withdrawal of the image transfer unit while in the engaged position;
withdrawing the released image transfer unit out of the image forming device to automatically clean a surface of the print head by rubbing a cleaning unit attached to the image transfer unit against the surface of the print head upon the withdrawal of the image transfer unit the relationship between the imaging member and the cleaning unit remaining constant during the withdrawal of the image transfer unit.

17. A method for refurbishing a customer replaceable unit for use in an image forming device having a print head, comprising:
inserting print media marking material in a marking material cartridge of the customer replaceable unit mountable within the image forming device adjacent a print head configured for imaging onto an imaging member within the image forming device, the customer replaceable unit including an image transfer unit configured to transfer a print image to a print media, and a cleaning unit directly attached to the image transfer unit, wherein the image transfer unit is a unitary member including both the marking material cartridge housing the print media marking material and a print cartridge housing an imaging member, the marking material cartridge and the an imaging member being coupled together independent of a spatial relationship between the image transfer unit and the image forming device, with the imaging member rotatably associated with the marking material cartridge, the imaging member and marking material cartridge being configured to maintain the coupling relationship there between during an insertion into the image forming device and during a withdrawal from the image forming device, the image forming device having an aperture configured to receive the image transfer unit for insertion of the image transfer unit into the image forming device to an engaged position for operation thereof, the image transfer unit having a distal end and a proximal end opposite the distal end, the distal end being fully inserted through the aperture when the image transfer unit is in the engaged position within the image forming device, wherein the cleaning unit is attached to the distal end of the image transfer unit the punt head configured for alignment in rubbing contact with the cleaning unit during the insertion or withdrawal of the image transfer unit, and the print head configured to shift towards an imaging member and out of rubbing contact alignment with the cleaning unit when the image transfer unit is in the engaged position with the print head configured to block insertion or withdrawal of the image transfer unit while in the engaged position, the relationship between the imaging member and the cleaning, unit remaining constant during the insertion and withdrawal of the image transfer unit, a shifting of the print head from the engaged position releasing the image transfer unit to a slideable configuration within the aperture of the image forming device;
reconditioning the cleaning unit of the customer replaceable unit, the cleaning unit configured to automatically clean a surface of the print head by rubbing against the surface of the print head upon an insertion or withdrawal of the cartridge within the image forming device.

18. The method of claim 17, the step of reconditioning the cleaning unit including cleaning the cleaning unit by removing contaminants from the cleaning unit previously accumulated onto a print head of an image forming device.

19. The method of claim 17, the step of reconditioning the cleaning unit including attaching a clean cleaning unit to the marking material cartridge.

20. The method of claim 17, the step of reconditioning the cleaning unit including replacing the cleaning unit with a clean cleaning unit.
